(19) United States
(12) Patent Application Publication
(10) Pub. No.: US 2019/0012747 A1
(43) Pub. Date: Jan. 10, 2019

(54) METHOD FOR MANAGING THE REPUTATION OF MEMBERS OF AN ONLINE COMMUNITY

(71) Applicant: TELECOM ITALIA S.p.A., Milano (IT)

(72) Inventors: Fabrizio ANTONELLI, Rosta (TO) (IT); Mattia PASOLLI, Trento (IT); Steven TAIT, Trento (IT); Michele VESCOVI, Trento (IT)

(73) Assignee: TELECOM ITALIA S.p.A., Milano (IT)

(21) Appl. No.: 16/063,901

(22) PCT Filed: Dec. 28, 2015
(86) PCT No.: PCT/EP2015/081293

§ 371 Date: Jun. 19, 2018

(51) Int. Cl. G06Q 50/00; G06Q 30/02

(52) U.S. Cl. CPC G06Q 50/01; G06Q 30/0282

(57) ABSTRACT

A method for managing reputation scores of members of an online community, wherein each member is associated with a set of inviting members having invited that member to join the online community and with a set of invited members having being invited by that member to join the online community. The method includes, for each member: determining a respective reputation score at the time when he/she joins the online community; and updating the respective reputation score based on a change in the reputation score of at least one of: at least one inviting member among the respective set of inviting members, or at least one invited member among the respective set of invited members.

### BACKGROUND OF THE INVENTION

### Field of the Invention

The present invention generally relates to online communities. More particularly, the present invention relates to a method (and a corresponding system) for managing the reputation (e.g., expressed in terms of reputation scores) of members of the online communities.

### Overview of the Related Art

The spread of the Internet and mobile connected devices led to an increase of online interactions between people, and especially to the growth of online communities, where people (or members of the online communities) share experiences, information and opinions.

Most of the socio-economical value generated in the online communities derives from services that rely on the interaction and on the exchange of information/assets among the members. For this reason trust among members is a key element for the success of the online communities. While in the real world people know themselves in person and assess their respective trustworthiness by direct experience and by observing each other, in the digital world there is a need to find alternative solutions for assessing mutual trust. For this reason digital services, based on online communities, need to implement mechanisms able to assess and track the trustworthiness of their members in a reliable and transparent way. These kind of solutions are usually referred to as “Reputation Management Systems” (hereinafter, RMS systems).

RMS systems are currently adopted by e-commerce systems and other exchange services at global level. In these RSM systems, customers/retailers need to evaluate the mutual trustworthiness or need to assess the reliability of published information. More in details, in some e-commerce systems, the members of the online community are represented by the set of subscribers (Sellers/Buyers) who perform e-commerce activities. According to a common approach, members are suggested to exploit textual feedback and stars ratings to support other sellers/buyers in assessing buyers/sellers reputation before starting any transaction. In this case, the reputation indicators are: the number of completed transactions, the rating average and a percentage of member satisfaction expressed on the basis of recent transactions.

US2008109244 discloses a method and a system for evaluating the quality of a contribution made by a user in a distributed online community framework. The quality of contribution is assessed by assigning a reputation score to the user across multiple online communities. The reputation scores of users are assigned on the basis of contributions of users and ratings received from other users for the contribution. The method provides for users to rate each other across multiple communities. Such a document further discloses a method and system for maintaining reputation profiles of users of online communities. The system also allows maintaining a unique reputation profile across the distributed online communities.

US20090070130 discloses a system and method that includes receiving a feedback score relating to a transaction engaged in by a user. The system and method also includes applying a weight to the feedback score based on weighting criteria to create a weighted feedback score. Further, generating a reputation score for the user based on the weighted feedback score may also be implemented. In an additional example embodiment, the system and method includes identifying a reputation score relating at least one neighbor of a user, the at least one neighbor of the user including another user with whom the user has engaged in a transaction. Further, the system and method includes ordering the reputation score relating to at least one neighbor of the user to create an ordered reputation score. Moreover, the system and method includes displaying the ordered reputation score.

### SUMMARY OF INVENTION

The Applicant has recognized that none of the cited prior-arts solutions is satisfactory.

Indeed, these prior-art solutions does not provide mechanisms that could reproduce, in any online community, the trust relations that establish among people interacting in the real world.

In view of the above, the Applicant has perceived that a need exists to reproduce, into the digital space of any online community a mechanism similar to that used in a real environment for assigning a score to the member of the online community so as to increase the overall quality of life of the online community, and, in order to achieve that, has devised a RMS system (and method) wherein a reputation score for each member of the online community is calculated and dynamically updated on the basis of the reputation scores of the members connected thereto (as well as on the basis of activity and inactivity of that members in the online community).

One or more aspects of the present invention are set out in the independent claims, with advantageous features of the same invention that are indicated in the dependent claims, whose wording is enclosed herein verbatim by reference (with any advantageous feature being provided with reference to a specific aspect of the present invention that applies mutatis mutandis to any other aspect).

More specifically, one aspect of the present invention relates to a method for managing reputation scores of members of an online community. Each member is associated with a set of inviting members having invited that member to join the online community and with a set of invited members having being invited by that member to join the online community. The method comprises, for each member:

determining a respective reputation score at the time when he/she joins the online community, and

updating the respective reputation score based on a change in the reputation score of at least one among
at least one inviting member among the respective set of inviting members, and
at least one invited member among the respective set of invited members.

According to an embodiment of the present invention, said updating the reputation score comprises, for each member, at least one among:
determining the change in the reputation score of the at least one inviting member occurred within a change time interval;
determining the change in the reputation score of each respective invited member within the change time interval;
weighting the change in the reputation score of the at least one inviting member and the change in the reputation score of each invited member according to a relevance to be attributed to the changes in the reputation scores of the inviting members with respect to the changes in the reputation scores of the invited members, and
applying the determined weighted changes in the reputation scores of the at least one inviting member and of each invited member to the reputation score of that member at a time instant from which the change time interval has started.

According to an embodiment of the present invention, said applying the determined weighted changes in the reputation scores comprises adding the weighted changes in the reputation scores to the reputation score to be updated.

According to an embodiment of the present invention, the method further comprises determining, for each member, an activity parameter indicative of each activity performed by that member in the online community. Preferably, said updating the reputation score of each member comprises, for each member, applying the activity parameter determined for that member to the reputation score of that member.

According to an embodiment of the present invention, said applying the activity parameter comprises adding the activity parameter to the reputation score to be updated.

According to an embodiment of the present invention, each activity belongs to a set of possible activities that are allowed to be performed in the online community. Preferably, said determining an activity parameter comprises, for each activity performed by each member:
determining a feedback parameter indicative of feedbacks received from other members of the online community in connection with that activity performed by that member, and
applying to the feedback parameter a weight parameter indicative of a relevance of that activity for the online community.

According to an embodiment of the present invention, the activity parameter is determined at each activity time interval. Preferably, said determining a feedback parameter is carried out at each feedback time interval indicative of a maximum time interval, from the time instant at which the activity has been performed, within which the feedbacks for that activity can be received. Even more preferably, the activity parameter is determined, for each member, according to those activities performed by that member during said activity time interval and whose feedback time interval has elapsed.

According to an embodiment of the present invention, the method further comprises determining, for each member, an inactivity parameter indicative of an inactivity time of that member in the online community. Preferably, said updating the reputation score of each member comprises, for each member, applying the inactivity parameter determined for that member to the reputation score of that member.

According to an embodiment of the present invention, said determining, for each member, an inactivity parameter is based on an inactivity function whose trend is compliant with at least one among the following conditions:
when an inactivity time of the member is below an inactivity time threshold by a first amount, the inactivity parameter takes a value close to a first value that does not significantly affect the reputation score of that member,
when the inactivity time of the member is above the inactivity time threshold by a second amount, the inactivity parameter takes a value close to a second value that significantly affects the reputation score of that member, and
when the inactivity time of the member is around the inactivity time threshold, the inactivity parameter takes a value close to an intermediate value between the first and second values.

According to an embodiment of the present invention, said determining, for each member, an inactivity parameter is based on an inactivity function having:
a constant trend, so that the activity parameter has a value independent from the inactivity time of that member; or
a linear trend, so that the activity parameter has a value linearly dependent on the inactivity time of that member; or
an exponential trend, so that the activity parameter has a value exponentially dependent on the inactivity time of that member.

According to an embodiment of the present invention, said applying the inactivity parameter comprises multiplying the reputation score to be updated, the activity parameter and the weighted changes in the reputation scores by said inactivity parameter.

According to an embodiment of the present invention, the inactivity parameter for each member is determined at each inactivity time interval. Preferably, the inactivity time interval is higher than, or equal to, the activity time interval. The feedback time interval is preferably lower than the activity time interval.

According to an embodiment of the present invention, the change time interval is higher than, or equal to, the activity time interval.

According to an embodiment of the present invention, said determining a reputation score for each member of the online community at the time when he/she joins the online community is based on at least one among:
amount and/or relevance and/or quality of personal data provided by that member upon joining the online community, and
the reputation score of the at least one inviting member.

According to an embodiment of the present invention, said determining a reputation score for each member of the online community at the time when he/she joins the online community is based on the reputation score of the inviting member, among said set of inviting members, whose invitation to join the online community has been accepted by that member.

Another aspect of the present invention relates to a computer program product directly loadable into a memory of a computer, the computer program product comprising software code means adapted to perform the method steps when run on the computer.

The mechanisms used in the computation of the reputation score promote and incentivize each single user toward a trustworthy behavior, the mutual responsibility/commitment and to the improvement of his/her own active contribution in the community also, for example, by inviting or by recommending other/new members of/in the community.

In this way, the trust score so calculated reproduces some trust mechanisms existing in the real world. The score is directly affected not only by the activities and behaviors of the participants, but it is also propagate in the community on the basis of a Network Evolution Topology of the community, that is the set of peers and connections created on invitation by each user while the network grows. In this way the trustworthiness of “connected” members (i.e. inviting/invited or recommended members) is reciprocally influenced by the trust score, activities and behaviors of the other members. As in the real world, where trustworthiness is not only evaluated in terms of individual properties but also from the properties of the community, the circles and the personal/professional relations involving each individual (see, e.g., the principle of the reference letters), this mechanism ensures the responsibility in mutually promoting each ones reputation.

A RMS system of this type is more adequate to generate a reliable trust score, if compared to the RMS systems already in use.

### BRIEF DESCRIPTION OF THE ANNEXED DRAWINGS

These and other features and advantages of the present invention will be made apparent by the following description of some exemplary and non-limitative embodiments thereof; for its better intelligibility, the following description should be read making reference to the attached drawings, wherein:

FIG. 1 schematically shows an overview of an environment according to an embodiment of the present invention;

FIG. 2 schematically shows, in terms of functional blocks, a “Reputation Management System” according to an embodiment of the present invention;

FIG. 3 shows an example of a DTS network for members of an online community;

FIG. 4 schematically shows a method for updating DTS scores of members of an online community according to an embodiment of the present invention, and

FIG. 5 shows an exemplary trend of a DTS time decay factor as a function of a number of days of inactivity of members of the online community according to an embodiment of the present invention.

### DETAILED DESCRIPTION OF PREFERRED EMBODIMENTS OF THE INVENTION

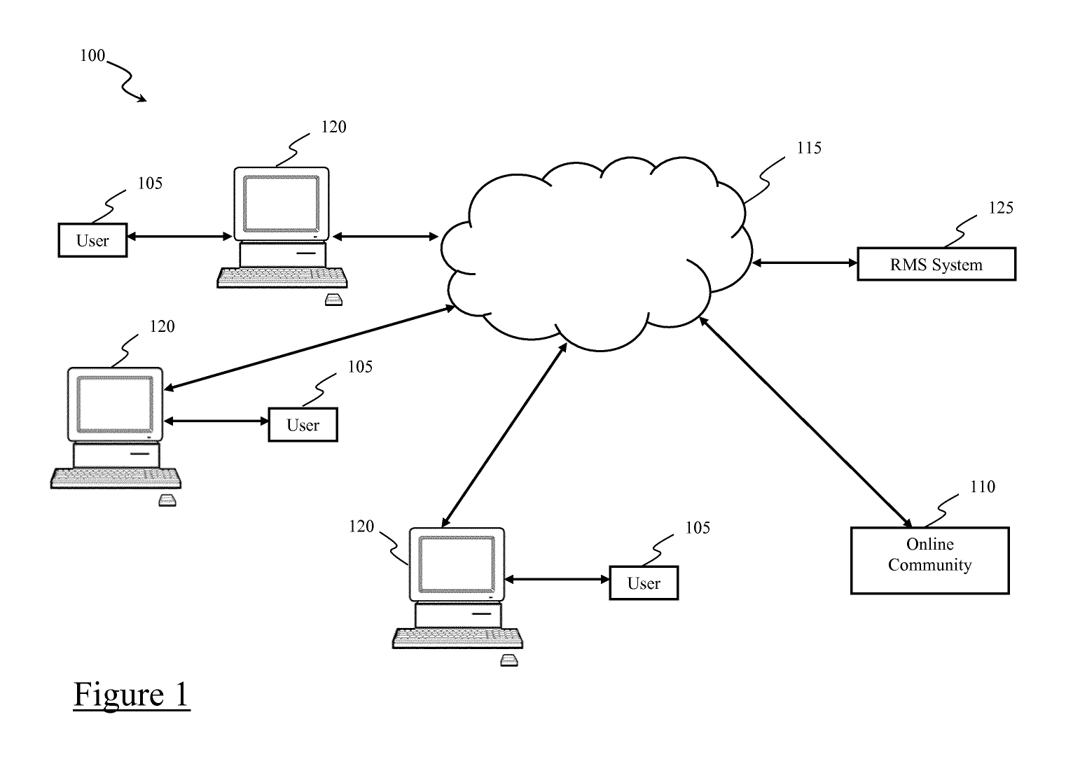

FIG. 1 is an overview of an environment 100 according to an embodiment of the present invention.

As shown in the figure, one or more users 105 can connect to one (as depicted) or more online communities 110 over a communication platform 115 (such as the Internet) through client devices 120 (such as personal computers, as depicted, or laptops, PDAs, or other devices with capabilities of communicating with the communication platform 115). It must be apparent to a person skilled in the art that although the Internet has been mentioned as example of communication platform 115, the present invention equivalently applies when other forms of network (e.g., LAN, WAN, mobile network, or a combination thereof) are considered. Moreover, as used herein, the term “online community” includes, without exception, discussion forums, blogs, social media platforms, e-commerce communities, photo and video sharing sites, business related communities and the like. In possible embodiments, all falling within the protection scope of the present invention, the term “online community” may also denote a subset of the online community (e.g., such as a friendship circles of each member of an online community).

The users 105 that are registered to the online community 110 (hereinafter referred to as members of the online community 110, or members) can participate in various activities across the online community 110 and make contributions. A “Reputation Management System” (hereinafter, RMS system) 125 is connected to the online community 110 and to the client devices 120 (and, hence, to the respective members) through the communication platform 115, for managing reputation scores of the members of that on line community 110.

The RMS system 125 may have a centralized nature (as herein exemplary assumed and illustrated), or a distributed nature. By way of example only, at least part of the RMS system 125 may be located at an online community server (not shown) hosting the online community 110—the online community server may be, for example, a computer server including a processor, transient memory (e.g., RAM), persistent memory (e.g., hard drive), input device and circuitry to provide communication paths between the components. Additionally or alternatively, the RMS system 125 may be arranged for managing the reputation scores of users 105 that are registered in multiple online communities 110. In this case, a RMS system 125 shared among multiple online communities 110 may be provided.

In general, the RMS system 125 is based on:
the members of the online community 110 (i.e., the users 105 that are registered to the online community 110);
a personal profile of each member (usually collected/built from a registration form), including a set of personal data/information (e.g., username, password, email and/or other attributes such as age, gender, date of birth, address);
a scope, i.e. domain or focus or objective, to which the reputation score determined by the RMS system 125 is referred—indeed, each online community 110 has a respective purpose, and the reputations score of the members of that online community 110 is usually evaluated taking into account only, or at least mainly, those parameters that affect the evolution of that online community 110 (for example, the reputation scores of members of a volley player community usually does not take into account football skills of the members, and the reputation scores of members of an e-commerce community usually does not take into account sympathy of the members);
policies, i.e. a set of operating modes, principles, rules, best practices, promoted/encouraged or respectively opposed activities and behaviors—for instance, in specific-domain announcement communities, the prohibition of publishing contents concerning different domains, or, in e-commerce communities, the mandatory, strongly suggested or optional rule of leaving feedbacks for transaction among the members;
indicators (such as feedback counter, credit rating, stars rating average) providing information about activities and, particularly, about the reputation of each member. Behaviors and actions/activities (both in terms of quantity and quality) of each member of the online community 110 affect over time the value of the indicators computed by the RMS system 125 (and, particularly, the reputation score of each member).

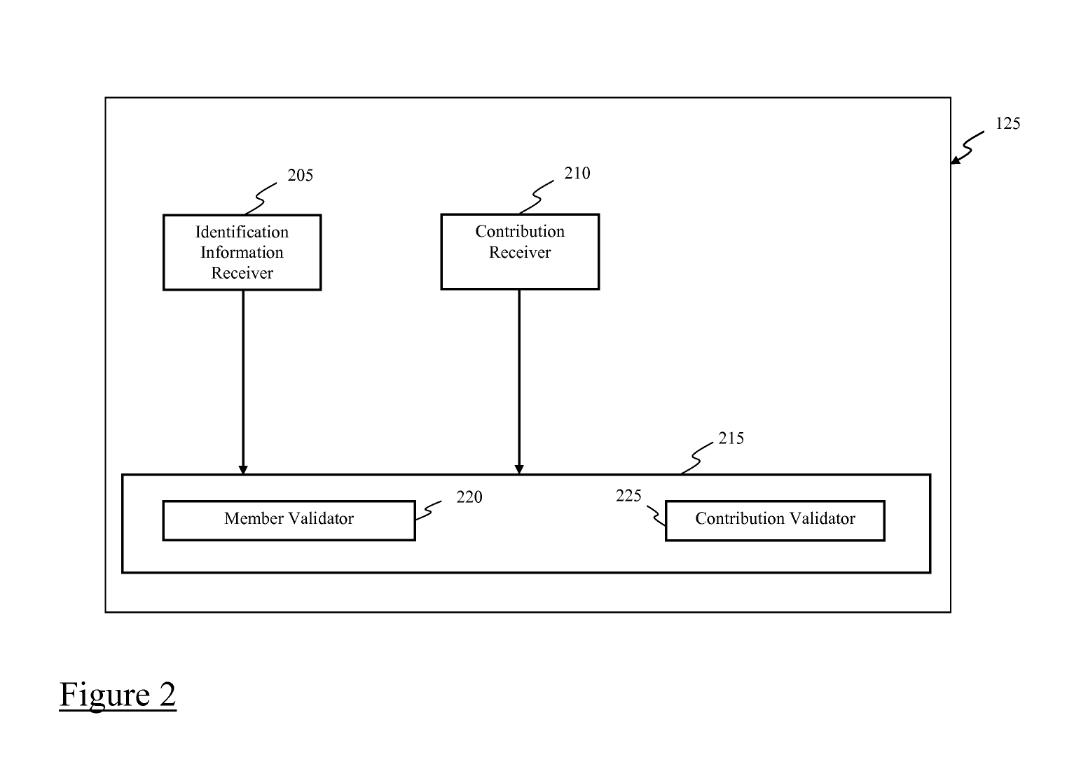

FIG. 2 schematically shows, in terms of functional blocks, a RMS system 125 according to an embodiment of the present invention.

As shown in the figure, the RMS system 125 comprises an identification information receiver 205 for receiving member identification information, and a contribution receiver 210 for receiving contributions of each member to the online community 110.

Contributions made by each member to the online community 110 may be in the form of comment, reply, query, photo, video or any other input given by the member to the online community 110. A member can give a rating to contributions made by other users. This rating may be quantitative or qualitative. Contributions can also be in the form of a member vote on an ongoing discussion in the online community. For example, if the online community is a blog, the contribution may be a comment on the blog. Similarly, if the online community is a Wiki, the contribution may be in the form of an article. In other embodiments, contribution by the member may be in the form of feedback, reply, query or the like.

The RMS system 125 preferably comprises a reputation controller 215 for determining and updating the reputation scores of the members. In addition, the reputation controller 215 preferably comprises a member validator 220 for analyzing the identification information to validate the member, and a contribution validator 225 for validating the member contribution.

Basically, the RMS system 125 is aimed at determining and managing (e.g., updating), for each member of the online community 110, a “Dynamic Trust Score” (hereinafter, DTS score), i.e. an evolved reputation score that allows taking into account the evolution of the online community 110 and of their members (as detailed below).

According to the principles of the present invention, the RMS system 125 operates as follows:
a DTS score for a new member is determined, for example by taking into account his/her personal data and/or his/her position in the online community 110 (i.e. who he/she is connected with, the meaning of connection among members being clarified in the following). As will be better understood from the following description, the DTS score for a new member is determined only when a new member has joined the online community 110, and, however, it can be determined independently from the following DTS score update (which instead is performed for all the members of the online community 110 at predetermined update time instants);
the DTS score for each member of the online community 110 is updated over time based on at least one among:
   i) activities performed by him/her within the online community 110 and feedbacks about the activities from one or more other members of the online community 110;
   ii) his/her inactivity in the online community 110;
   iii) a change in the reputation score of at least one member connected thereto (i.e., having a relation within the online community 110), hereinafter referred to as connected members.

### Determination of the DTS Score for a New Member

According to an embodiment of the present invention, a user 105 (not yet included in the online community 110) can join the online community 110 (thereby becoming a new member m_{new}) via an invitation (hereinafter referred to as DTS invitation) from a member that is already part of the online community 110 (hereinafter referred to as inviting member m_{old}). Hence, a DTS invitation comprises an inviting member m_{old} and an invited member (i.e., the member that, upon acceptance of the DTS invitation, will become the new member m_{new}—in the following, also the invited member being denoted by the symbol m_{new}).

A DTS invitation can thus be defined as follows:

$$INV ( {m}_{old} , {m}_{new} , t ) = \{ \begin{matrix}{m}_{old} {\to }^{invited} {m}_{new} \\ {m}_{new} {\to }^{accepted invitation at time t} {m}_{old}\end{matrix} \}$$

i.e. a DTS invitation is instantiated (i.e. stored, and the invited member m_{new} becomes part of the online community 110) only when, at the time instant t, the invited member m_{new} accepts it.

According to embodiments of the present invention, each member may be associated with a set of (zero, one or more) inviting members having invited that member m to join the online community 110 and with a set of (zero, one or more) invited members having being invited by that member m to join the online community 110.

Preferably, the DTS invitation for a new member can be initialized only by an old member (i.e., a user 105 that is already a member of the online community 110) and, in case of multiple invitations to join the online community 110, only the first invitation accepted by the invited member m_{new} becomes valid and is tracked into the RMS system 125 (i.e., in the reputation controller 215 thereof) as a DTS invitation.

Preferably, it is assumed the existence of an initial member mᵣₒₒₜ of the online community 110 (e.g., a fictitious member, or an administrator of the RMS system 125). Consequently, the set of first members of the online community 110 (since its creation or earlier accepted in it) could be considered as invited by the initial member mᵣₒₒₜ.

According to an embodiment of the present invention, a new member m_{new} can also join the online community 110 with no direct invitation (e.g., when his/her identity can be verified at a centralized level, e.g. by means of the member validator 220), in which case he/she will be considered to be invited by the initial member mᵣₒₒₜ by default.

According to the previous definitions, the following property holds for DTS invitations:

∀mⱼ,mⱼ≠mᵣₒₒₜ·∃!mᵢ,t:INV(mᵢ,mⱼ,t)

which means that for each member (denoted by mⱼ in the above mathematical relation) different from the initial member mᵣₒₒₜ, always exists only one member (denoted by mᵢ in the above mathematical relation) that invited him/her and whose invitation has been accepted at the time instant t. In the following, a generic member will be also denoted by m.

The set of connections created on DTS invitations by the members m of the online community 110 identify, as a whole, a connection network (hereinafter, DTS network). The DTS network can be represented as a directed graph where the vertices are the members of the online community 110 and the edges correspond to the DTS invitations (invitation relations among the members). For example, there is a direct edge (m_{old}, m_{new}) between a couple of members, if the two members are connected because an invited member m_{new} accepted the invitation of an inviting member m_{old}, and thus a DTS invitation INV (m_{old}, m_{new}, t) exists. In other words, the DTS network reflects the trusted relations between the members of the online community 110.

To this purpose, given a set of members C of the online community 110, the DTS Network Ň_{C} of C can be defined as the graph:

Ň_{C}=(V_{C},E_{C})

wherein

V_{C}=C

E_{C}={(mᵢ,mⱼ)|∃mᵢ,mⱼϵVc,∃t·INV(mᵢ,mⱼ,t)}

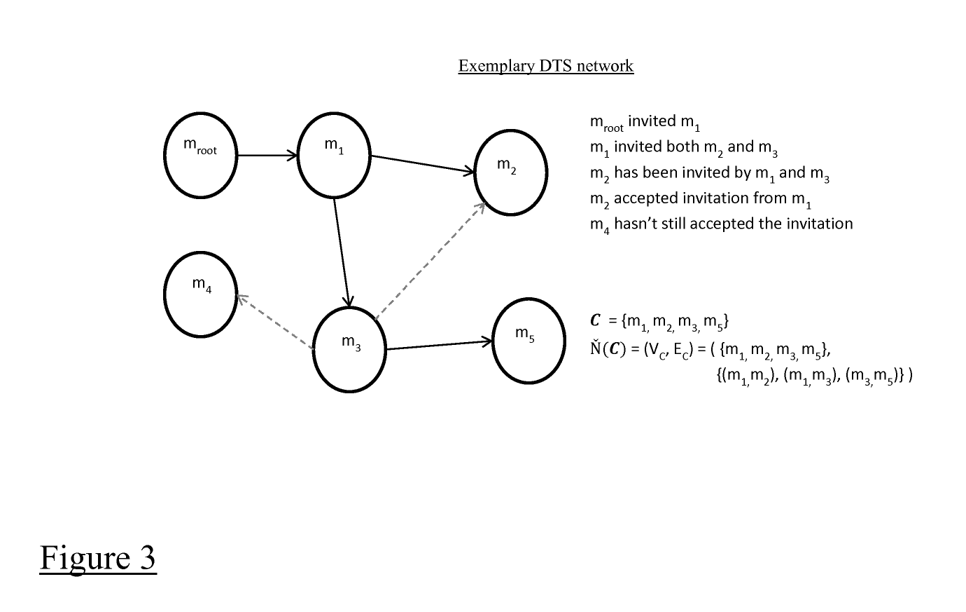

In particular, given the above property holding for DTS invitations, the DTS network is a (direct) tree, rooted in mᵣₒₒₜ. This is schematically shown in FIG. 3 for an exemplary DTS network (in such a figure, a continuous line representing a DTS invitation, a dashed line instead representing a refused or not accepted (or not yet accepted) invitation that hence cannot be defined as a DTS invitation).

In embodiments of the present invention wherein no initial member mᵣₒₒₜ is set, the DTS network is a (direct graph) tree forest, where the initial/former members of the on line community 110 are the roots of the different (direct) trees.

According to an embodiment of the present invention, the RMS system 125 could store and keep track of the invitations received and not accepted (but not refused) by a new member m_{new}, although only one invitation (the first accepted/confirmed) per new member m_{new} should become his/her DTS invitation. The remaining (not refused) invitations could be stored in a proper memory (not shown) of the RMS system 125 (e.g., in the reputation controller 125) as well as in the direct edges (of different type) of the DTS network graph for different purposes; in this case the DTS network would become a DAG (“Direct Acyclic Graph”) instead of a tree. Formally, every invitation that has not yet been accepted nor rejected by a new member m_{new} can be defined as:

$$END ( {m}_{i} , {m}_{j} ) = {m}_{i} {\to }^{endorsed} {m}_{j}$$

As a result, the direct acyclic graph Ň_{C}^{EXT} can be defined as:

Ň_{C}^{EXT}=(V_{C},[E_{C}∪E_{S}])

by extending the DTS Network with the addition of the set of edges representing the invitations, where:

E_{S}={(mᵢ,mⱼ)|∃mᵢ,mⱼϵV_{C},∃t·END(mᵢ,mⱼ,t)}

Additionally or alternatively, an invitation to a new member m_{new} could be stored even when it follows a DTS invitation that has been already accepted by that new member m_{new}. This can enable various extensions for taking into account different scenarios that may arise during the “life” of the online community 110. For example, by keeping track of the invitations not accepted/refused, it could be possible for a member m at a certain point of time to repudiate (e.g., with a penalty) his/her inviting member (in case that the mutual trustworthiness has passed) and switching to another member belonging to an endorsement/invitation list of that member m. Not accepted/rejected invitations could also be used in case the inviting member of a member leaves the online community 110.

As should be readily understood, according to specific implementations of the RMS system 125 (in turn depending on the intended context), different scenarios could also be envisaged without affecting the principles of the present invention. For example, the RMS system 125 may take into account the following scenarios:
a member m wishes to leave the online community 110. In this case, the members having the member m as their inviting member become “abandoned” members, and may decide to recognize as their inviting member the respective previous member in the DTS network or they may decide to request to some other members connected to them because of an endorsement to become their inviting member. If none of these options is available, the initial member mᵣₒₒₜ is preferably considered, by default, as the inviting member of the “abandoned” members, or the active members of the online community 110 could be allowed to invite the “abandoned” members;
the member m wishes to change the inviting member. In this case, the member m may request to some other members connected to him/her because of an endorsement to become his/her inviting member. This action could be performed for many reasons: for example to change the inviting member (because the member m has more trust in another member) or to repudiate him/her (due to a lack of trust). Eventually a penalty in the DTS score of the member m may be decided in this case; the penalty could also be different based on the reason of the change of the invited member.
the member m wishes to repudiate an invited member. The member invited by the member m may decide to recognize as his/her inviting member the ancestor member in the DTS network, or he/she may request to some other members connected to him/her because of an endorsement to become his/her inviting member. If none of the members is available the inviting member of penalty in the DTS score of both members could be decided in this case.

According to an embodiment of the present invention, the DTS score of each new member m_{new} is calculated by first assigning an initial DTS score to that member m_{new} at the time he/she joins the online community 110.

As the new member m_{new} has not yet performed any activity, the value of his/her initial DTS score is preferably determined according to at least one among amount and/or relevance and/or quality of personal information provided by that new member m_{new} upon joining the online community 110 (assuming that the disclosure of more identifiable information makes the user more recognizable and more trustworthy), and the DTS score of one or more inviting members among the set of inviting members. More preferably, in the light of the considered preferred embodiment wherein only the inviting member (among the set of inviting members) whose invitation to join the online community 110 has been accepted is considered as the actual inviting member, the value of initial DTS score for the new member m_{new} is determined according to at least one among amount and/or relevance and/or quality of personal data provided by that new member m_{new} upon joining the online community 110, and the DTS score of his/her inviting member.

In other words, the value of the initial DTS score for each new member m_{new} is preferably determined according to at least one among:
(i) his/her accountability (i.e., the transparency and credibility of the self-information provided), and
(ii) his/her inherited reputation (i.e., a certain level of trustworthiness arising from his/her DTS invitation, so that the reputation of a new member m_{new} is somehow guaranteed by the reputation of the inviting member m_{old}).

Formally, being t₀ the time instant at which the DTS invitation INV(m_{old}, m_{new}, t₀) has been created, i.e. the time instant at which the new member m_{new} accepts a the invitation of an inviting member m_{old} and joins the online community 110, the initial DTS score can be defined as follows:

IDTS(m_{new})=DTS(m_{new},t₀)=[α·DTS(m_{old},t₀)]+[/β·ACC(m_{new})]

wherein:
IDTS(m_{new}) is the initial DTS core of the new member m_{new};
DTS(m_{new}, t₀) is the DTS score of the new member m_{new} at the time instant t₀ he/she joins the online community 110 (and corresponding, exactly, to the initial DTS score of that new member m_{new});
α and β are factors depending on the specific implementation. Preferably, the values α and β are weight factors for the associated terms (i.e. DTS(m_{old}, t₀), and ACC(m_{new}), respectively). Preferably, αϵ (0,1] and β ϵ[0,1];
DTS(m_{old}, t₀) is the current value of the DTS score of the inviting member m_{old}, i.e. the value of the DTS score at the time t₀ at which the initial DTS score IDTS (m_{new}) is computed. As should be readily understood, the higher the value of the factor α, the greater the influence of the reputation of the inviting member m_{old} (i.e., of his/her DTS score) on the determination of the initial DTS score of the invited member m_{new}; and
ACC(m_{new}) is an optional accountability score calculated for the new member m_{new}, that is a measurable indicator of the accountability of the new member m_{new} computed in terms of amount of personal information provided by him/her to the RMS system 125 (such as name, birth date, address, occupation, and the like) while filling the registration form.

According to an embodiment of the present invention, the more the personal information provided by the new member m_{new} about himself/herself, the more her/his identity (and thus her/his accountability) can be verified. Anyway, other alternative indicators, such as the certification or the verification of the information provided by the new member m_{new} can also be used in embodiments of the present invention (e.g., the mobile phone number can be verified by SMS, the e-mail address can be verified by e-mail, the address can be verified by mail, and the like) as well as other personal information that can be verified by the online community members (e.g., if a certain number of members of the online community 110 confirm the registered identity, this can be considered truthful with a high likelihood). As mentioned above, in determining the initial DTS score, the accountability score ACC(m_{new}) is optional and dependent on the specific implementation. In particular, the accountability score ACC (m_{new}) for a new member m_{new}, which takes into account the amount of personal information provided by him/her, has the property of further increasing the value of the associated DTS score, otherwise calculated only based on the DTS score of the inviting member m_{old}. If no personal information, other than those strictly required, is used, the accountability score ACC(m_{new}) will have a null effect (being for example set to zero). In addition, as should be readily understood, the greater the value of the factor β, the higher the influence of the accountability of the new member m_{new} when determining his/her initial DTS score inter alia, the optional nature of the accountability score ACC(m_{new}) can also be observed from the value range set out above for the factor β (i.e., βϵ[0,1]), wherein the 0 is included, as opposed to the value range set out above for the factor α (i.e., αϵ(0,1]), wherein instead the value 0 is not included, it meaning that in the considered embodiment the current value of the DTS score for the inviting member m_{old} (i.e., DTS(m_{old}, t₀) is in each case considered for evaluating the initial DTS core of the new member m_{new} (i.e., IDTS(m_{new})). According to an embodiment of the present invention, let \vec{d} be a binary vector of length n, where n is the number of attributes/parameters (e.g., mandatory or optional personal information) requested to any invited member m_{new} during her/his registration to the online community 110 (e.g., by filling the registration form), then the accountability score ACC(m_{new}) for the invited member m_{new} may be calculated as follows:

$$ACC ( {m}_{new} ) = \vec{γ} \cdot \vec{d} = {\sum }_{i = 1}^{n} {γ}_{i} \cdot {d}_{i}$$

wherein:
dᵢ takes the value 1 if the new member m_{new} has provided (or certificated) the i-th attribute/parameter, or the value 0 otherwise. The distinction between “provided” and “certified” is meant to discern embodiments wherein the RMS system 125 simply requires that personal information is provided from embodiments wherein the RMS system 125 demands that personal information is provided and certified (e.g., through a centralize check: certificate scanning or other prove in order that this personal information could contribute to increase the accountability); and
\vec{γ} is a vector of n real factors, with γᵢϵ[0,1] for 1<i<n, wherein the value of each factor γᵢ can be set discretionally by the digital service provider depending on the relevance (in terms of trust, transparency, service-provisioning, and the like) of the i-th attribute/parameter requested. Thus, γᵢ represents the weight factor of each i-th attribute/parameter, such that the higher the value of the factor γᵢ, the greater the influence of providing/certifying a particular personal information on the determination of the initial DTS score of a new member m_{new} (e.g., the weight factor γᵢ relating the personal mobile phone number could be set at a higher value than the value of the weight factor γᵢ relating the age of the member).

Updating the DTS Score Over Time

For the sake of convenience, from now on reference will be made to a generic member m of the online community 110, without distinction between new and old members (indeed, as mentioned above, the updating of the DTS score over time preferably involve equally, i.e. indiscriminately, all the members of the online community 110).

Broadly speaking, the DTS score of each member m is updated or actualized over time in order to always better represent the changing reputation/trustworthiness of each member m in his/her online community 110, for instance according to the quantity and quality of the actions/activities performed by that member m in the online community 110 (e.g., according to a number of activities, to a type of activity, to a success/resolution state thereof, or to an influence thereof on the online community 110 in terms, for example, of number of involved members m and of importance of the activity), according to his/her participation (e.g., how often he/she performs certain activities), according to evaluations provided by the other members m on his/her activities (e.g., positive or negative feedbacks), and/or according to activities of the other members m of the online community 110 connected (through the DTS network) to that member m.

According to an embodiment of the present invention, the DTS score of a member m can be adjusted/updated by taking into account at least one among the following factors (or parameters):
an activity factor (hereinafter, DTS activity factor) taking into account the activities performed by a member m of the online community 110 and the feedbacks related to such activities received from the other members;
a time decay factor (hereinafter, DTS time decay factor) taking into account (being for example proportional to) the level of activity/inactivity of a member m over time. For example, the DTS time decay factor may ensure that the DTS score is decreased for those members m which are inactive (i.e., which perform no activities) for significant time periods; and
a propagation factor (hereinafter, DTS propagation factor) taking into account, for each member m, the influence of the members m connected to him/her (through the DTS network). Thus, the DTS propagation factor reflects the trusted relations among the members m in the DTS network. Otherwise stated, the DTS propagation factor for each member m takes into account the change of his/her DTS score due to activities performed by, or feedbacks received from the members connected thereto, rather than due to his/her direct activities/feedbacks (i.e., due to the activities performed by, or feedbacks received from that member m).

Preferably, in order to perform the DTS score update, it is sufficient that at least one among the DTS factors (i.e., the DTS activity factor, the DTS time decay factor and the DTS propagation factor) is affected, and hence that at least one among the associated events takes place. In other words, in order to perform the DTS score update of a member m, it is sufficient that at least one among the following events takes place: an activity (with received feedback) performed by that member m, an activity (with received feedback) performed by a member connected to that member m, and inactivity of that member m.

According to embodiments of the present invention, only a subset of the DTS factors (or, equivalently, of the associated activities), are considered. Additionally or alternatively, the DTS factors (or a subset thereof) are considered when predetermined conditions occur (e.g., a time threshold) or for specific (e.g., groups of) members. For example:
according to an embodiment of the present invention, only the DTS activity factor and the DTS propagation factor are considered, whereas the negative effect of the inactivity of the members m on their reputation (and, hence, the DTS time decay factor) is ignored;
according to another embodiment of the present invention, all the three DTS factors are considered, but the DTS time decay factor is applied only for a new member of the online community 110 and only after a predetermined time threshold (e.g., 6 months).

In the following, possible embodiments of the DTS activity factor, of the DTS time decay factor and of the DTS propagation factor will be discussed in greater detail.

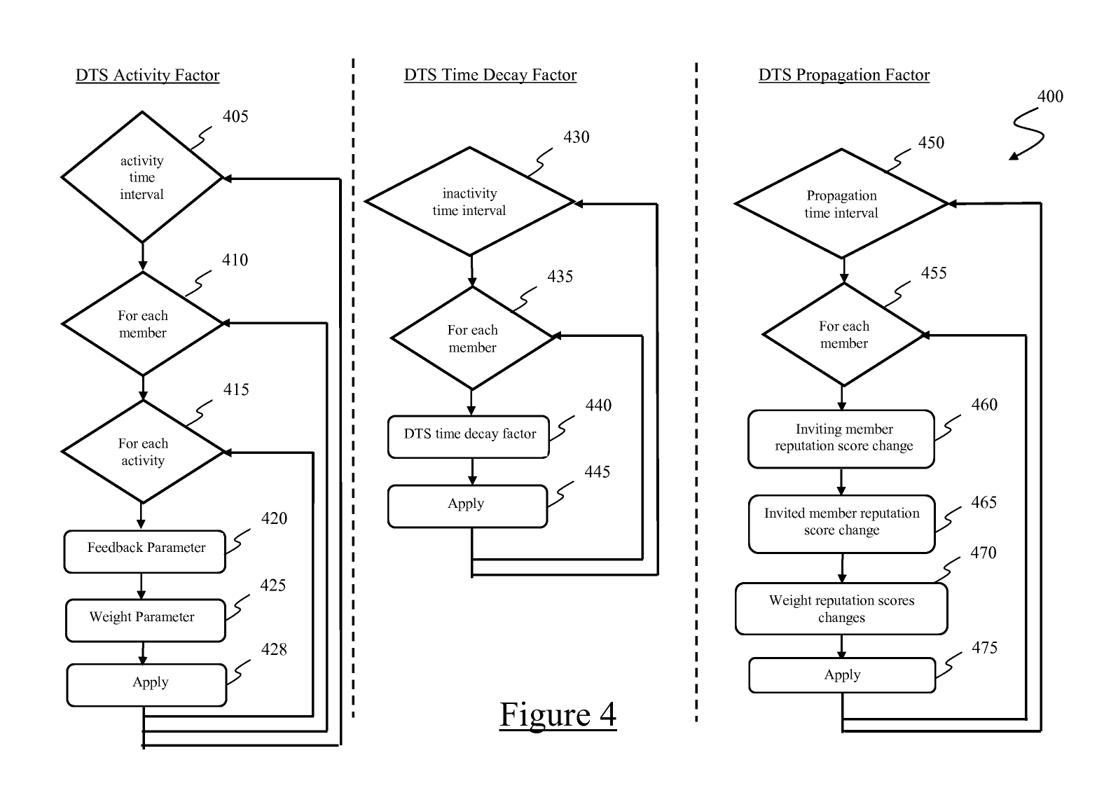

As should be understood, the computations of the DTS activity factor, of the DTS time decay factor and of the DTS propagation factor may be regarded as corresponding steps of a method, e.g. implemented by the reputation controller 215, for updating the DTS score of each member of the online community 110. This method may be in the form of software code means adapted to perform respective steps (corresponding to the mathematical relations discussed below) when run on a computer (e.g., of the reputation controller 215), the software code means being adapted to be included in a computer program product loadable into a memory of a computer for being run on it (for the purposes of the present invention, the term “computer” being construed in its broader meaning of any device having processing/computing capabilities, including for example a microprocessor or an application-specific integrated circuit (ASIC)). A conceptual representation of main method steps corresponding to the computation of the DTS activity factor, of the DTS time decay factor and of the DTS propagation factor are shown in FIG. 4. In such a figure, the method is denoted as a whole by the number reference 400, and the parallel arrangement of the method steps corresponding to the computation of the DTS activity factor, of the DTS time decay factor and of the DTS propagation factor is illustrated for convenience only, without denoting any time relation—indeed, as better discussed in the following, the updating of the DTS score is based on the DTS activity factor and/or on the DTS time decay factor and/or on the DTS propagation factor according to the compliance with respective time interval constraints.

DTS Activity Factor

According to an embodiment of the present invention, the DTS activity factor is determined and applied to the DTS score to be updated.

Preferably, the DTS activity factor contributes in updating the DTS score of a member m by “awarding” (i.e., increasing) his/her DTS score when he/she strongly contributes in the online community 110, by performing (many) “good” activities and being positively evaluated for his/her contributes in such activities by the other members of the online community 110. On the contrary, the DTS activity factor preferably contributes in decreasing the trustworthiness of the member m (i.e., by decreasing his/her DTS score) when he/she performs “bad” activities or his/her activities are negatively evaluated by the other members of the online community 110.

Even more preferably, in order to achieve that, the DTS activity factor is added to the DTS score to be updated.

The activity of each member m can be identified by a set of possible activities that are allowed to be performed in the online community 110. According to an embodiment of the present invention, each possible activity A that can be performed by a member m is described by one or more (preferably all) the following parameters:
activity name Aₙₐₘₑ;
activity type A_{type}, i.e. the kind of activity performed by the member m in the digital or real environment (such as adding some content, making a recommendation, translating a good to another member);
activity cardinality A_{card}, i.e. the cardinality of the other members (different from the member m) involved (i.e., in relation with) the activity. For example, the cardinality may be represented by a couple of numbers respectively representing the number of members performing the activity (also referred to as performers) and the number of members affected by (e.g., receiving/taking advantage of the effect of) the activity (also referred to as receivers). The possible cardinalities are the following (the symbol N indicating many members, i.e. more than one member):
   1:1, representing an activity from one single member toward another single member (e.g., the sale of a good);
   1:N, representing an activity from one single member toward many (more than one) other members (e.g., the insertion of a content available to others);
   N:1, representing an activity from many (more than one) members to one member (e.g., the “following” activity in which more members support one other single member in performing one activity, such as moving home);
   N:N, representing an activity from many (more than one) members toward many members (e.g., a couple of members which help more than one other members, such as social event organization).
activity weight A_{weight}, i.e. a weight parameter indicative of the relevance/impact of the activity performed by the member m for the online community 110 (i.e., in the scope and with respect to the type of digital service to which the RMS system 125 applies). Preferably, the more the activity is relevant, critical, difficult, demanding (in terms of effort) or important for the other members m of the online community 110 with respect to the domain and digital service to which the RMS system 125 applies, the higher the activity weight A_{weight} assigned to the activity. According to an embodiment of the present invention, the activity weight A_{weight} is a real value ϵ[0, 1] that can take the value 0 if the associated activity is considered irrelevant for determining the trustworthiness of a member, or the value 1 for those activities that are considered more relevant/important for the online community 110. Just as an example, the activity weight A_{weight} could depend on the value of a product (e.g., in case of product loan), or on the time dedicated to the activity (e.g., a loan time);
activity feedback type A_{ft}; as all the different activities performed by the member m have impact on the overall operation, performance and affluence of the online community 110, the other members can provide a feedback on the activities performed by that member m by evaluating their quality (positive or negative) and effectiveness. By way of example only, the activity feedback type A_{ft} can be:
   None, i.e. not expected for that kind of activity;
   Simple, i.e. discriminating between positive or negative (optionally neutral);
   Weighted, i.e. associating a rate to the activity (the rate could be, for example, a real number or a scale of progressive numbers including, eventually, also negative ratings).

Summarizing, each activity A that is allowed to be performed by each member m of the online community 110 can be defined by the following tuple:

A=<Aₙₐₘₑ,A_{type},A_{card},A_{weight},A_{ft}>

and all the possible activities allowed by the nature, the domain and the extent/scope of the digital service to which the RMS system 125 applies define, as a whole, an activity dictionary, wherein each entry of the activity dictionary is a tuple.

Just as an example, in the context of a digital service that allows members to share events and add comments, the activity dictionary could contain the following entries (the activity feedback type A_{ft} being omitted):
A₁=<“add new event”, “add event”, “1:N”, 1>
A₂=<“add comment to event”, “add comment”, “1:N”, 0.2>
A₃=<“reply to comment”, “reply”, “1:1”, 0.1>

Thus, in the above example, three activities A₁, A₂, A₃ are possible having activity weights A_{1weight}, A_{2weight} and A_{3weight} of 1, 0.2 and 0.1, respectively.

With reference to the activities dictionary, the activities performed by any member m of the online community 110 are preferably registered as the set MA (m) called member activities, where every single member activity a is defined and stored as a tuple:

aϵMA(m) and a=<aₘ,a_{A},aₜ,a_{FB}>

In particular such a tuple represents the fact that the member m performed the activity A, at the time instant t, and that such an activity has collected from the other members a set of feedbacks (hereinafter, feedback set) FB. The feedback set FB can either contain many feedbacks or be an empty set (if the activity did not collect any feedback from the other members). All the single feedbacks fbϵFB should be consistent with the activity feedback type A_{ft}, i.e. with the feedback types expected for the activity A. In practice an activity a is a precise instantiation (given a member, the time and the collected feedbacks) of a generic activity A.

Some embodiments of the present invention can include in the member activities of the member m also the list of the other members respectively participating (i.e., supporting m) or being the beneficiaries/receivers of the activity, depending on the activity cardinality A_{card}. This information can be used jointly with the respective DTS scores of these members in order to update the DTS score of the member m (e.g., the positive effects of the activities performed by the member m could be increased by the fact of having performed an activity jointly with a member with high reputation or, vice-versa, in favor of a member with low reputation (generosity), while negative effects could be increased if the activity has been performed jointly with a low reputation member).

Let be defined as:

r(a_{FB})

a feedback parameter whose value aggregates all the feedbacks in the feedback set FB with a=<aₘ, a_{A}, aₜ, a_{FB}>. For example, the feedback parameter r(a_{FB}) can take the average value of all the feedback ratings collected for an activity evaluated by means of a weighted activity feedback type A_{ft}, or it can take the modal value among all the positive/negative feedbacks for an activity evaluated by means of a simple activity feedback type A_{ft} (neutral if positive and negative feedbacks are equivalently numerous). It should be noted that when, as herein assumed, it is possible to leave a feedback for an activity only for a limited time interval (set, for example, by the digital service provider, as detailed in the following), the DTS activity factor for a specific activity may be calculated only when this time interval has elapsed.

In general, given a=<aₘ, a_{A}, aₜ, a_{FB}>, the feedback parameter r(a_{FB}) takes a real value according to the following rule:

$$r ( {a}_{FB} ) ∈ \{ \begin{matrix}\{ 1 \} & if {A}_{ft} is None or no feedbacks are available for a ( i . e . FB = φ ) \\ \{ - 1 , 0 ; + 1 \} & if {A}_{ft} is Simple and FB \neq φ \\ [ - 1 ; + 1 ] & if {A}_{ft} is Weighted and FB \neq φ\end{matrix}$$

It should be noted that in case of a simple activity feedback type A_{ft}, the feedback parameter r(a_{FB}) can take the value 0 for those cases in which a “substantial equilibrium” between positive and negative feedbacks can lead the RMS system 125 to consider the activity performed by the member m neutral, i.e. not relevant to increase or decrease the reputation/trustworthiness of that member m.

In any case, the principles of the present invention are not limited to how multiple feedbacks received for a member activity a (and contained in a_{FB}) are aggregated each other in order to obtain the feedback parameter r(a_{FB}).

Let be further defined MA(m, tᵢ₋₁, t₁)⊆MA(m) as the subset of member activities MA(m) performed by the member m between the time instants tᵢ₋₁ and tᵢ, formally:

MA(m,tᵢ₋₁,tᵢ)={a|aϵMA(m) and tᵢ₋₁<aₜ<tᵢ}

and MA(m, t₁)⊆MA(m) as the subset of member activities MA(m) performed by the member m from the instant he/she joined the community until the instant tᵢ, formally:

MA(m,tᵢ)={a|aϵMA(m) and aₜ≤tᵢ}

Thus, the DTS activity factor f_{A} for the member m in the time interval tᵢ₋₁→tᵢ can be defined as:

$${f}_{A} ( m , {t}_{i - 1} , {t}_{i} ) = {\sum }_{\begin{matrix}a ∈ MA ( m , {t}_{i - 1} , {t}_{i} ) , \\ a = < {a}_{m} , {a}_{A} , {a}_{t} , {a}_{FB} >\end{matrix}} {A}_{weight} \cdot r ( {a}_{FB} )$$

In practice, the DTS activity factor f_{A} takes into account the quantity and the quality (weights and feedbacks) of all the activities performed by the member m in a specific time interval. It should be noted that the more are the activities performed by the member m (the quantity being given by the cardinality of the set MA(m, tᵢ₋₁, tᵢ)), the higher is the number of contributes of the sum of the equation above. These contributes can lead to a positive or negative impact on the DTS activity factor f_{A} depending on the characteristic of each activity (in particular the activity type a_{A}, its activity weight A_{weight} and on the feedback provided by the other community members a_{FB}). As a result, the DTS activity factor f_{A} can result in a positive or negative value for the specified time interval. In addition, if the member m is not active in the specified time window (i.e., he/she does not perform any activity), he/she will have a DTS activity factor f_{A} equal to zero.

The above discussion can be conceptually summarized by the method steps represented in the left column of FIG. 4. According to such a representation, the method 400 comprises, for each activity performed by each member m:

determining (action node 420) the feedback parameter r(a_{FB}) indicative of feedbacks received from other members of the online community 110 in connection with that activity performed by that member m,

applying (action node 425) to the feedback parameter r(a_{FB}) the weight parameter A_{weight} indicative of a relevance of that activity for the online community 110, and applying (action node 428) the weighted feedback parameter to the DTS score to be updated.

As above mentioned, these steps are preferably applied for each member (as conceptually illustrated in the figure by loop connection between the action node 428 and the decision node 410), and for each activity (as conceptually illustrated in the figure by loop connection between the action node 428 and the decision node 415). Even more preferably, as detailed below, these steps are applied for each activity whose feedback time interval (indicative of a maximum time interval, from the time instant at which the activity has been performed, within which the feedbacks for that activity can be received) has elapsed at the time of the computation of the DTS activity factor.

Back to the example of the previously defined scenario (i.e., a digital service that allows members to share events and add comments), and assuming that:
C={m₁, m₂, m₃, m₅}, i.e. the online community has four members;
AD={A₁, A₂, A₃}, i.e. three possible activities affecting the DTS score are foreseen in the activity dictionary;
MA(m₁)={<m₁, A₁, tᵣₑₐₗ₁, FB₁={0.6; 0.8; 0.1}>}, i.e. the member m₁ shared an event (as indicated by the activity type A₁) at the time instant tᵣₑₐₗ₁ and has received three feedbacks for it (collected in the respective feedback set FB₁);
MA(m₃)={<m₃, A₂, tᵣₑₐₗ₂, FB₂={1; 1}>, <m₃, A₁, tᵣₑₐₗ₃, FB₃={0.2; −0.3; −0.5}>}, i.e. the member m₃ added a comment (as indicated by the activity type A₂) at the time instant tᵣₑₐₗ₂ and has received two feedbacks for it (collected in the respective feedback set FB₂), and shared an event (as indicated by the activity type A₁) at the time instant tᵣₑₐₗ₃ and has received three feedbacks for it (collected in the respective feedback set FB₃);
MA(m₅)={<m₅, A₂, tᵣₑₐₗ₄, FB₄={−1; 1; −1}>, <m₅, A₃, tᵣₑₐₗ₅, FB₅−{1; 1}>}, i.e. the member m₅ added a comment (as indicated by the activity type A₂) at the time instant tᵣₑₐₗ₄ and has received three feedbacks for it (collected in the respective feedback set FB₄), and replied to a comment (as indicated by the activity type A₃) at the time instant tᵣₑₐₗ₅ and has received two feedbacks for it (collected in the respective feedback set FB₅), and that
the value r(a_{FB}) is given by the feedback average,

then the DTS activity factor f_{A} for the members m₁, m₃ and m₅ in the time interval t₁→t₂ (with t₁<tᵣₑₐₗ₁, . . . , tᵣₑₐₗ₅<t₂) according to an embodiment of the present invention is the following:

f_{A}(m₁,t₁,t₂)=A_{1weigth}*r(a_{FB1})=1*0.5=0.5

f_{A}(m₃,t₁,t₂)=A_{2weigth}*(a_{FB2})+A_{1weigth}*r(a_{FB3})=0.2*1+1*−0.2=0

f_{A}(m₅,t₁,t₂)=A_{2weigth}*r(a_{FB4})+A_{3weigth}*r(a_{FB5})=0.2*−1+0.1*1=−0.1

In this example, based on the performed activities, the DTS activity factor f_{A} (and, hence, the DTS score) of the member m₁ will have an increment, the DTS activity factor f_{A} (and, hence, the DTS score) of the member m₃ will remain stable, whereas the DTS activity factor f_{A} (and, hence, the DTS score) of the member m₅ will have a decrement.

DTS Time Decay Factor

Generally, the trust level of a member m is strongly related to his/her continuous activity in the online community 110, considering especially his/her recent activity (where the concept of “recent” is relative to a specific time window defined for a specific RMS system 125).

According to the present invention, the introduction of the DTS time decay factor (or inactivity factor) avoids that the DTS score of a member remains fixed for an indefinite time, despite the fact that the member does not perform any activities. To this purpose, the DTS time decay factor is strongly related to the activity rate of a member over a “recent” time so as to capture a long inactivity of the member (basically, the time interval from the last activity performed by that member to a present time instant, i.e. the time instant at which the DTS score is updated).

In particular, let tᵢ be a specific time instant during the life of the RMS system 125 and let tᵢ₋ₖ, with tᵢ₋ₖ<tᵢ, be a former instant in which the last activity performed by the member m has been registered; formally:

tᵢ₋ₖ=max{t|aϵMA(m,t) and a=<aₘ,a_{A},aₜ,a_{FB}>}

and

[symbol]

j|MA(m,tᵢ₋ₖ,tⱼ)≠Ø,tᵢ>tⱼ>tᵢ₋ₖ

The time interval elapsed within tᵢ and tᵢ₋ₖ represents an inactivity time of the member m at the time instant tᵢ (and denoted by inactivity (m, tᵢ)) i.e. the longest time interval up to the time instant tᵢ in which no activity has been performed by the member m. Accordingly, the inactivity time of the member m is formally defined as follows:

inactivity(m,tᵢ)=max{k|MA(m,tᵢ₋ₖ)≠Ø,k>0}

According to an embodiment of the present invention, the inactivity time inactivity (m, tᵢ) at the time instant tᵢ is used in the computation of the DTS time decay factor f_{T} (m, tᵢ) at the time instant tᵢ. As mentioned above, the DTS time decay factor f_{T} (m, tᵢ) is a factor used for updating/actualizing the DTS score of a member m with respect to his/her inactivity, i.e. it is used to periodically decrease the trustworthiness/reputation of the member m if he/she is inactive in the online community for too long periods.

The function (or trend) implementing the DTS time decay factor f_{T}(m, tᵢ) can be defined in different ways, depending on the rules and objectives of the specific RMS system 125. By way of example only, the function could be:
a constant function, which means that the decrease of the DTS score caused by inactivity of the member m is constant independently from how long is the inactivity period; or
a linear function, which means that the decrease of the DTS score caused by inactivity of the member m is proportional to the duration of his/her inactivity (e.g., the longer the inactivity of the member m at the instant tᵢ, the higher the value of the DTS time decay factor f_{T}(m, tᵢ), in which case the linear function is an increasing linear function); or
an exponential function, which means that the decrease of the DTS score caused by inactivity of the member m may be more important in certain periods than other ones (for example, during an occasional event, such as a holiday, the immediate inactivity of a member m, i.e. during that event, may have a higher importance than mid-term or long-term inactivity of the member m, i.e. outside that event).

Additionally to the determination of the DTS time decay factor f_{T}(m, tᵢ) based on a function that substantially takes into account the inactivity of a member, such as the exemplary constant, linear and exponential functions above discussed, embodiments of the present invention may provide the determination of the DTS time decay factor f_{T}(m, tᵢ) also based on the level of activity/inactivity of the online community 110 as a whole. In this respect, according to embodiments of the present invention, the determination of the DTS time decay factor f_{T}(m, tᵢ) is based also on the activity (for example, the average activity) of all the members of the online community 110 (or of a significant part thereof, e.g. including a significant number of members, and/or trusted members and/or popular members), such that, for example, for the same member inactivity, the DTS time decay factor f_{T}(m, tᵢ) is decreased more quickly when the members of the online community 110 (or the significant part thereof) are highly active than when they are scarcely active.

According to a preferred embodiment of the present invention, the DTS time decay factor f_{T}(m, tᵢ) is calculated as follows:

$${f}_{T} ( m , {t}_{i} ) = ( 1 - floor ) * \{ \begin{matrix}\frac{{tan}^{- 1} ( k - cons ) + π / 2}{π} & if k = inactivity ( m , {t}_{i} ) > ɛ \\ 1 & otherwise\end{matrix}$$

wherein
ε is an inactivity time threshold indicative of an inactivity time interval allowed between two activities without substantially penalizing the member m;
cons is a variable representing the point where the DTS time decay factor f_{T}(m, tᵢ) increases abruptly (and the penalization of the member m for his/her inactivity becomes more significant), and
floor is a variable representing a bottom limit to avoid to continuously decrease the DTS score till zero, with floorϵ(0,1].

According to the exemplary disclosed embodiment, the above formula for the DTS time decay factor f_{T}(m, tᵢ) makes use of an inverse-tangent function. According to the inverse-tangent function:
when the inactivity time of a member is below the inactivity time threshold ε by a first amount, the inactivity parameter takes a value close to a first value (e.g., 1) that does not significantly affect the DTS score of that member;
when the inactivity time of a member is above the inactivity time threshold ε by a second amount (different from, or equal to, the first amount) the inactivity parameter takes a value close to a second value (e.g., 0) that significantly affects the reputation score of that member, and
when the inactivity time of the member is around the inactivity time threshold ε, the inactivity parameter takes a value close to an intermediate value between the first and second values.

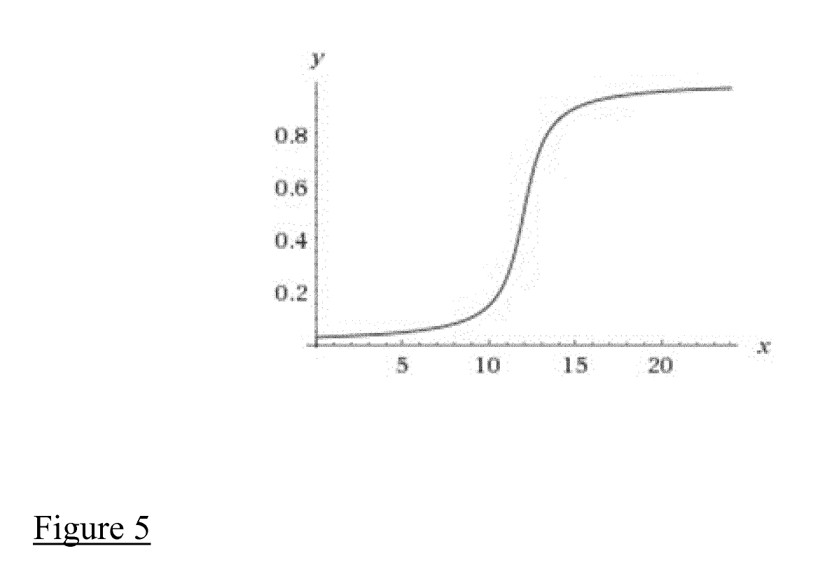

FIG. 5 shows an exemplary trend of the DTS time decay factor f_{T}(m, tᵢ) as a function of a number of days of inactivity. In the illustrated example, the variable cons is set at 12, in correspondence of which the DTS time decay factor f_{T}(m, tᵢ) is equal to 0.5, which means that if the member remains inactive for 12 days beyond the inactivity time threshold ε, his/her DTS score will undergo a substantial reduction.

Assuming that the variable floor is set at 0.6, after 10 days of inactivity beyond the inactivity time threshold ε the DTS time decay factor f_{T}(m, tᵢ) takes the value 0.04, after 15 days of inactivity beyond the inactivity time threshold ε the DTS time decay factor f_{T}(m, tᵢ) takes the value 0.2, whereas after 20 days of inactivity beyond the inactivity time threshold ε the DTS time decay factor f_{T}(m, tᵢ) takes the value 0.4. Thus, by definition:

$${f}_{T} ( m , {t}_{i} ) ∈ \{ \begin{matrix}1 & if k < ɛ \\ [ ( 1 - floor ) ; 1 ] & if k > ɛ\end{matrix}$$

According to an embodiment of the present invention, the DTS time decay factor f_{T}(m, tᵢ) is used as a multiplicative coefficient to update the DTS score of the member m: when the DTS time decay factor f_{T}(m, tᵢ) is equal to 1 the DTS score is unvaried, otherwise the DTS score is proportionally decreased by the DTS time decay factor f_{T}(m, tᵢ). As will be apparent from the following description, this multiplicative coefficient has to be multiplied to the DTS score to be updated, to the DTS activity factor and to the DTS propagation factor.

The above formula for the DTS time decay factor f_{T}(m, tᵢ) simulates what can happen in the real life: at the beginning, a certain time of inactivity, in this case an inactivity not greater than the inactivity time threshold ε, is considered normal and tolerated, thus it does not influence the DTS time decay factor f_{T}(m, tᵢ). Then, after such an inactivity time threshold ε is overcome, the DTS time decay factor f_{T}(m, tᵢ) starts decreasing, first smoothly for shorter inactivity periods, then more consistently for longer ones. After very long inactivity periods, the DTS time decay factor f_{T}(m, tᵢ) remains almost stable, decreasing very slowly.

As should be readily understood, although the above formula for the DTS time decay factor f_{T}(m, tᵢ) makes use of an inverse-tangent function, same or similar trends could be achieved with other functions without affecting the principles of the present invention.

The above discussion can be conceptually summarized by the method steps represented in the middle column of FIG. 4. According to such a representation, the method 400 comprises, for each member m:
determining (action node 440) the DTS time decay factor indicative of the inactivity of that member m, and
applying (action node 445) the DTS time decay factor to the DTS score to be updated, said applying preferably comprising multiplying the DTS time decay factor by the DTS score to be updated, and, when provided, to the DTS activity factor and to the DTS propagation factor.

As above mentioned, these steps are preferably applied for each member (as conceptually illustrated in the figure by loop connection between the action node 445 and the decision node 435).

In addition, as conceptually illustrated in the figure by loop connection between the action node 445 and the decision node 430, these steps are applied at each predetermined time interval (hereinafter, inactivity time interval).

DTS Propagation Factor

According to the present invention, the reputation/trustworthiness of a member m does not depend and/or vary only on the basis of his/her initial reputation and subsequent behaviors (represented by the activities performed by the member m), but it also strongly depends on the behavior of the other members in relation with the member m, or, otherwise stated, on the behavior of the members connected with the member m in the DTS network. Like in real world relationships, in fact, the trustworthiness of an individual is evaluated by other individuals also on the basis of the behaviors and trustworthiness of the people that the individual trusts, supports, is supported by and interacts/goes with, and in particular of the members that that person invited to be part of the community.

In order to achieve that, the DTS propagation factor represents the influence of the members in relation with the member m on the trustworthiness/reputation of the member m. Concretely, the DTS propagation factor propagates the updates/variations of the DTS scores of the members of the online community 110 over their connected members (edges in the DTS network).

Basically, the DTS propagation factor introduces a (positive or negative) variation/change in the DTS score of a member m, said variation being evaluated on the basis of the updates/variations of the DTS scores of the other members of the community connected with that member m. More practically, if a member m is connected with (i.e., he/she invited or has been invited by) other members of the community having at the current time an increasing reputation, he/she will gain more reputation/trustworthiness (i.e., the DTS score will be incremented due to a positive DTS propagation factor); on the contrary, if a member m is connected with other members having at the current time a decreasing reputation/trustworthiness he/she will lose some reputation/trustworthiness (i.e., the DTS score will be decremented due to a negative DTS propagation factor).

Let be the variation of the DTS score of the member m (denoted by ΔDTSᵣⁱ (m)) between two time instants tᵢ and tᵣ defined as follows:

ΔDTSᵣⁱ(m)=DTS(m,tᵢ)−DTS(m,tᵣ), with tᵣ<tᵢ

and let m_{old} be the (inviting) member that invited the member m at the time instant t₀ (i.e., INV (m_{ood}, m, t₀) according to the above notation), and {m_{invited}^{j}}ⱼ the set of invited members having been invited by the member m at time instants t_{0+θj}, with θⱼ>0 (i.e., {INV(m, m_{invited}^{j}, t_{0+θj})}ⱼ according to the above notation), so that the member m is connected with the inviting member m_{old} and the invited members {m_{invited}^{j}}ⱼ in the DTS network, i.e.:

{m_{old},m}∪{m_{invited}^{j}}ⱼ⊆V_{c} and {m_{old},m)}∪{(m,m_{invited}^{j})}ⱼ⊆E_{c}

then, the DTS propagation factor for the member m at the time instant tᵢ with respect the time instant tᵣ (denoted by fₚ (m, tᵣ, tᵢ) can be defined as follows:

$${f}_{P} ( m , {t}_{r} , {t}_{i} ) = δ \cdot Δ {DTS}_{r}^{i} ( {m}_{old} ) + ( {\sum }_{j} {δ}^{′} \cdot Δ {DTS}_{r}^{i} ( {m}_{invited}^{j} ) )$$

wherein
ΔDTSᵣⁱ(m_{old}) is the variation of the DTS score of the inviting member m_{old} between the time instants tᵢ and tᵣ;

ΔDTSᵣⁱ(m_{invited}^{j}) is the variation of the DTS score of each invited member m_{invited}^{j} having being between by the member m between the time instants tᵢ and tᵣ (according to different embodiments of the present invention, as mentioned above, the invited members could be regarded either the members invited by a member m and having accepted the invitation, or the members invited by a member m and having not accepted the invitation); and
δ and δ′ are parameters (preferably, arbitrary chosen by the digital service provider) indicative of how much the variation of the DTS score of the inviting member m_{old} and of each invited member {m_{invited}^{j}}ⱼ respectively, impacts on the DTS score of the member m.

Back to the example of DTS network illustrated in FIG. 3, and assuming that:
δ=0.02 and δ′=0.01, it meaning that the reputation/trustworthiness of a member m is affected more from the behavior of the inviting member m_{old} rather than from those of the invited members {m_{invited}^{j}}^{j}; and that
the DTS scores of the members m₁, m₃, m₅ at the time instant tᵣ and at the time instant tᵢ are, respectively:
   DTS(m₁, tᵣ)=25 DTS(m₃, tᵣ)=28 DTS(m₅, tᵣ)=12
   DTS(m₁, tᵢ)=22 DTS(m₃, tᵢ)=30 DTS(m₅, tᵢ)=16
thus the DTS variation for the members m₁, m₃, m₅ between the time instants tᵣ and tᵢ is:
   ΔDTSᵣⁱ(m₁)=−3 ΔDTSᵣⁱ(m₃)=2 ΔDTSᵣⁱ(m₅)=4
and the DTS propagation factor for the member m₃ is:

$$\begin{matrix}{f}_{P} ( {m}_{3} , {t}_{r} , {t}_{i} ) = δ \cdot Δ {DTS}_{r}^{i} ( {m}_{1} ) + {δ}^{′} \cdot Δ {DTS}_{r}^{i} ( {m}_{5} ) \\ = 0.02 \cdot ( - 3 ) + 0.01 \cdot 4 \\ = - 0.02\end{matrix}$$

meaning that the member m₃ will have a slightly negative impact on his/her reputation based on the behavior of the members m₁ and m₅.

The above discussion can be conceptually summarized by the method steps represented in the right column of FIG. 4. According to such a representation, the method 400 comprises, for each member m:
determining (action node 460) the change in the reputation score of the inviting member occurred within a predetermined time interval (hereinafter, change time interval or propagation time interval);
determining (action node 465) the change in the reputation score of each respective invited member within the propagation time interval;
weighting (470) the above changes in the reputation scores by the respective parameters δ and δ′, and
applying (475) the weighted changes in the reputation scores so determined to the reputation score of that member at the time instant from which the propagation time interval has started, said applying preferably comprising adding the weighted changes in the reputation scores to the reputation score to be updated.

As above mentioned, these steps are preferably applied for each member (as conceptually illustrated in the figure by loop connection between the action node 475 and the decision node 455).

In addition, as conceptually illustrated in the figure by loop connection between the action node 475 and the decision node 450, these steps are applied at each predetermined time interval (hereinafter, change time interval or propagation time interval).

As mentioned above, the RMS system 125 is arranged for updating or actualizing the DTS score of each member m over time in order to represent the changing reputation/trustworthiness of each member m in his/her community 110.

All the events occurring in the RMS system 125 and in the associated community 110 (e.g. activities, feedbacks, invitations, etc.) happen continuously over time, at precise time instants tᵣₑₐₗ. Each time instant tᵣₑₐₗ thus represents the time instant, in the real world (for example, with a time resolution of the order of seconds), at which a specific event occurs (thus, it will be referred to as real time instant tᵣₑₐₗ).

Basically, according to the present invention, the DTS score update/actualization does not takes place in correspondence of every event (i.e., at every real time instant tᵣₑₐₗ), but that it takes place at update time instants {tⱼ}ⱼ, scheduled by the RMS system 125 according to a proper policy. Preferably, the updating time instants {tⱼ}ⱼ are scheduled (e.g., determined and/or predetermined) based on:
pre-fixed time intervals (e.g., one week, one day, one hour, etc.), and/or
the occurrence of predetermined trigger events (e.g., every time a new member joins the community 110 or every time a certain—set or amount—of activity (activities) is (are) performed in the RMS system 125).

According to an embodiment of the present invention, given the real time instants tᵣₑₐₗ during which an activity/event occurs in the RMS system 125, the same activity/event could be considered to occur at the time instant t such that:

t=max{tⱼ|tⱼ≤tᵣₑₐₗ,tⱼϵ{tᵢ}}.

In other words, an event is associated with one of the scheduled update time instants {tⱼ}ⱼ instead of the actual real time instant tᵣₑₐₗ at which that event has occurred. Preferably, as formally expressed in the above equation, the event occurred at the real time instant tᵣₑₐₗ is associated with the update time instant {tⱼ}ⱼ that, among the scheduled update time instants {tⱼ}ⱼ, is immediately before that real time instant tᵣₑₐₗ.

Preferably, let be defined {tᵢ}ᵢ⊆{tⱼ}ⱼ as the set of time instants at which the DTS scores of all the members of the community may be computed (hereinafter, computation time instants), such that, for a member m, the DTS score DTS(m, tᵢ) at the computation time instant tᵢ is computed on the basis of the DTS score DTS (m, tᵢ₋₁) at the computation time instant tᵢ₋₁ by applying the various DTS factors previously described, and such that:

∀tⱼ,tᵢ₋₁<tⱼ<tᵢ:DTS(m,tⱼ)=DTS(m,tᵢ₋₁)

In other words, the DTS score of the member m remains constant between two consecutive computations time instants tᵢ₋ₗ and tᵢ. According to alternative embodiments of the present invention, the computation time instants and the updating time instants may also correspond.

Preferably, the update time instants {tⱼ}ⱼ at which the DTS scores of all the members of the community 110 (or of a subset thereof) are updated/actualized are determined by considering the above-discussed DTS factors (or a subset thereof), i.e. the DTS activity factor, the DTS time decay factor, and the DTS propagation factor. More preferably, the update time instants {tⱼ}ⱼ are determined by taking into account the following parameters (or, respectively, a subset thereof):
feedback time interval Δ_{FB}: maximum time interval, starting from the time instant at which a member activity takes place, within which any member involved in the activity (or any member allowed/enabled to do it) can provide feedbacks for that specific activity (and the member having carried out that activity, can receive the feedbacks). The feedback interval Δ_{FB} affects the computation of the DTS activity factor, because each activity can result either in a positive or negative contribute to the update of the DTS score of a member, also depending from the quality and quantity of the feedbacks received by such an activity. In other words, the feedback interval Δ_{FB} identifies the time window within which a feedback for a certain activity can be released, i.e. only when such a time window ends that activity is considered for determining the DTS activity factor;
activity time interval Δ_{A}: minimum time interval that occurs between two consecutive computations of the DTS activity factor;
decay time interval Δ_{T}: minimum time interval that should elapse between two consecutive computations of the DTS time decay factor, i.e. the time interval after that a perpetrating inactivity of a member can lead to a further decay of his/her DTS score after a previously applied decay. If a member activity falls into the defined time interval the member is not considered inactive and no further decay is applied to his/her DTS score;
propagation time interval Δ_{P}: minimum interval that occurs between two consecutive computations of the DTS propagation factor.

Thus, the feedback Δ_{FB}, activity Δ_{A}, time decay Δ_{T} and propagation Δ_{P} time intervals represent time windows within which activities should take place. These activities provide their contribution to the DTS score only at the end of these time windows (and not in the real time instant t real at which these activities are performed).

Preferably, the method 400 for updating the DTS scores of the members of the community (preferably all the members, or at least a subset thereof) is run by the RMS system 125 in order to comply with proper timing relationships between the feedback Δ_{FB}, activity Δ_{A}, time decay Δ_{T} and propagation Δ_{P} time intervals. Even more preferably, the method 400 is run as follows.

Firstly, the DTS scores at the time instant tᵢ are actualized on the basis of the previous DTS scores at the time instant tᵢ₋₁, by eventually applying the DTS time decay factor due to members inactivity if a time decay interval Δ_{T} is passed from the last previous computation of the DTS time decay factor (see loop connection between the action node 445 and the decision node 430 in FIG. 4).

Then, the DTS scores are further updated by eventually adding the contribute of the DTS activity factors if an activity interval Δ_{A} is passed from the last previous computation of the DTS activity factors (see loop connection between the action node 425 and the decision node 405 in FIG. 4), and if the feedback interval is expired Δ_{FB} for each activity performed the currently considered member (i.e., if at the current time all the possible feedbacks related to the member activities performed before tᵢ have been collected)—see loop connection between the action node 425 and the decision node 415 in FIG. 4).

Finally, the DTS scores of all the community members are (eventually) updated by taking into account the contribute coming from the changes in the trustworthiness of the connected members if the DTS propagation time interval Δ_{P} has elapsed. This is made by means of the application of the DTS propagation factor. As mentioned above, the application of the DTS propagation factor is preferably carried out only when the DTS scores of all the members have been individually updated on the basis of their activity/inactivity, thus it is convenient that the feedback Δ_{FB}, activity Δ_{A}, time decay Δ_{T} and propagation Δ_{P} time intervals satisfy the following relation:

Δ_{FB}<<Δ_{A}≤Δ_{T},Δ_{P}

Anyway, the feedback Δ_{FB}, activity Δ_{A}, time decay Δ_{T} and propagation Δ_{P} time intervals are not limiting for the present invention. According to alternative embodiments of the present invention, the feedback Δ_{FB}, activity Δ_{A}, time decay Δ_{T} and propagation Δ_{P} time intervals are all set to the same value.

An exemplary pseudo-code algorithm implementing the above procedure 400 for updating the DTS scores DTS(m, tᵢ) of every member m of the community at tᵢ<tᵣₑₐₗ may be the following (wherein t_{A} will denote the last time instant at which the DTS activity factor for the all the members of the community was computed, t_{T} will denote the last time instant at which the DTS time decay factor for all the members of the community was computed, and t_{P} will denote the last time instant at which the DTS propagation factor for all the members of the community was computed):

for all mϵC:DTS(m,t_{I})=DTS(m,tᵢ₋₁)

if tᵢ≥t_{T}+Δ_{T}

then for all mϵC:DTS(m,tᵢ)=DTS(m,tᵢ₋₁)·F_{T}(m,tᵢ); then t_{T}=tᵢ

if tᵢ≥tᵣₑₐₗ−Δ_{FB} and tᵢ≥t_{A}+Δ_{A}

then for all mϵC:DTS(m,tᵢ)=DTS(m,tᵢ)+f_{A}(m,t_{A},tᵢ), then t_{A}=tᵢ

if tᵢ≥t_{P}+Δ_{P}

then for all mϵC:DTS(m,tᵢ)=DTS(m,tᵢ)+fₚ(m,t_{P},tᵢ); then t_{P}=tᵢ

To provide a quantitative example, let be assumed, for example, that a member m performs activities at real time instants tᵣₑₐₗ₁, tᵣₑₐₗ₂, tᵣₑₐₗ₃, tᵣₑₐₗ₄, tᵣₑₐₗ₅, tᵣₑₐₗ₆, tᵣₑₐₗ₇, and that the DTS scores are computed at computing time instants t₀, t₁₀, t₂₀, t₃₀, such that

tᵣₑₐₗ₁<tᵣₑₐₗ₂<tᵣₑₐₗ₃<tᵣₑₐₗ₄<tᵣₑₐₗ₅<tᵣₑₐₗ₆<tᵣₑₐₗ₇

t₀<tᵣₑₐₗ₁,

tᵣₑₐₗ₄<t₁₀<tᵣₑₐₗ₅,

tᵣₑₐₗ₆<t₂₀<tᵣₑₐₗ₇

t₃₀>tᵣₑₐₗ₇

and that the activity Δ_{A}, propagation Δ_{P} and decay Δ_{T} time intervals are equal to (and hence the DTS activity factor, the DTS propagation factor and the DTS time decay factor are updated every) 10, 10 and 20 days, respectively, then the DTS scores are computed as follows:

DTS(m,t₁₀)=DTS(M,t₀)+f_{A}(M,t₁₀)+fₚ(M,t₁₀)

DTS(M,t₂₀)=[DTS(M,t₁₀)+f_{A}(M,t₂₀)+f_{P}(m,t₂₀)]·fₜ(M,t₂₀)

DTS(m,t₃₀)=DTS(m,t₂₀)+f_{A}(M,t₃₀)+f_{P}(M,t₃₀)

Assuming instead that the activity Δ_{A}, propagation Δ_{P} and decay Δ_{T} time intervals are all equal to (and hence the DTS activity factor, the DTS propagation factor and the DTS time decay factor are all updated every) 10 days, the DTS scores are computed as follows:

DTS(M,t₁₀)=[DTS(m,t₀)+f_{A}(M,t₁₀)+f_{P}(m,t₁₀)]·f_{T}(m,t₁₀)

DTS(m,t₂₀)=[DTS(m,t₁₀)+f_{A}(m,t₂₀)+f_{P}(m,t₂₀)]·f_{T}(m,t₂₀)

DTS(m,t₃₀)=[DTS(m,t₂₀)+f_{A}(m,t₃₀)+f_{P}(m,t₃₀)]·f_{T}(m,t₃₀)

Naturally, in order to satisfy local and specific requirements, a person skilled in the art may apply to the solution described above many logical and/or physical modifications and alterations. More specifically, although the present invention has been described with a certain degree of particularity with reference to preferred embodiments thereof, it should be understood that various omissions, substitutions and changes in the form and details as well as other embodiments are possible. In particular, different embodiments of the invention may even be practiced without the specific details set forth in the preceding description for providing a more thorough understanding thereof; on the contrary, well-known features may have been omitted or simplified in order not to encumber the description with unnecessary details. Moreover, it is expressly intended that specific elements and/or method steps described in connection with any disclosed embodiment of the invention may be incorporated in any other embodiment.

More specifically, the present invention lends itself to be implemented through an equivalent method (by using similar steps, removing some steps being not essential, or adding further optional steps); moreover, the steps may be performed in different order, concurrently or in an interleaved way (at least partly).

1-16. (canceled)

17. A method for managing reputation scores of members of an online community, wherein each member is associated with a set of inviting members having invited that member to join the online community and with a set of invited members having being invited by that member to join the online community, the method comprising, for each member:
determining a respective reputation score at the time when he/she joins the online community; and
updating the respective reputation score based on a change in the reputation score of at least one of:
at least one inviting member among the respective set of inviting members, or
at least one invited member among the respective set of invited members.

18. A method according to claim 17, wherein the updating the reputation score comprises, for each member:
determining the change in the reputation score of the at least one inviting member that has occurred within a change time interval;
determining the change in the reputation score of each respective invited member within the change time interval;
weighting the change in the reputation score of the at least one inviting member and the change in the reputation score of each invited member according to a relevance to be attributed to the changes in the reputation scores of the inviting members with respect to the changes in the reputation scores of the invited members; and
applying the determined weighted changes in the reputation scores of the at least one inviting member and of each invited member to the reputation score of that member at a time instant from which the change time interval has started.

19. A method according to claim 18, wherein the applying the determined weighted changes in the reputation scores comprises adding the weighted changes in the reputation scores to the reputation score to be updated.

20. A method according to claim 17, further comprising:
determining, for each member, an activity parameter indicative of each activity performed by that member in the online community,
the updating the reputation score of each member comprising, for each member, applying the activity parameter determined for that member to the reputation score of that member.

21. A method according to claim 20, wherein the applying the activity parameter comprises adding the activity parameter to the reputation score to be updated.

22. A method according to claim 20, wherein each activity belongs to a set of possible activities that are allowed to be performed in the online community, the determining an activity parameter comprising, for each activity performed by each member:
determining a feedback parameter indicative of feedbacks received from other members of the online community in connection with that activity performed by that member, and
applying to the feedback parameter a weight parameter indicative of a relevance of that activity for the online community.

23. A method according to claim 22, wherein the activity parameter is determined at each activity time interval, wherein the determining a feedback parameter is carried out at each feedback time interval indicative of a maximum time interval, from a time instant at which the activity has been performed, within which the feedbacks for that activity can be received, and wherein the activity parameter is determined, for each member, according to those activities performed by that member during the activity time interval and whose feedback time interval has elapsed.

24. A method according to claim 17, further comprising:
determining, for each member, an inactivity parameter indicative of an inactivity time of that member in the online community,
the updating the reputation score of each member comprising, for each member, applying the inactivity parameter determined for that member to the reputation score of that member.

25. A method according to claim 24, wherein in the determining, for each member, an inactivity parameter is based on an inactivity function whose trend:
when an inactivity time of the member is below an inactivity time threshold by a first amount, the inactivity parameter takes a value close to a first value that does not significantly affect the reputation score of that member,
when the inactivity time of the member is above the inactivity time threshold by a second amount, the inactivity parameter takes a value close to a second value that significantly affects the reputation score of that member, and
when the inactivity time of the member is around the inactivity time threshold, the inactivity parameter takes a value close to an intermediate value between the first and second values.

26. A method according to claim 24, wherein the determining, for each member, an inactivity parameter is based on an inactivity function including:
a constant trend, so that the activity parameter has a value independent from the inactivity time of that member; or
a linear trend, so that the activity parameter has a value linearly dependent on the inactivity time of that member; or
an exponential trend, so that the activity parameter has a value exponentially dependent on the inactivity time of that member.

27. A method according to claim 24, wherein the applying the inactivity parameter comprises multiplying the reputation score to be updated, the activity parameter, and the weighted changes in the reputation scores by the inactivity parameter.

28. A method according to claim 24, wherein the inactivity parameter for each member is determined at each inactivity time interval, the inactivity time interval being higher than, or equal to, the activity time interval and the feedback time interval being lower than the activity time interval.

29. A method according to claim 23, wherein the change time interval is higher than, or equal to, the activity time interval.

30. A method according to claim 17, wherein the determining a reputation score for each member of the online community at the time when he/she joins the online community is based on at least one of:
amount and/or relevance and/or quality of personal data provided by that member upon joining the online community, or
the reputation score of the at least one inviting member.

31. A method according to claim 30, wherein the determining a reputation score for each member of the online community at the time when he/she joins the online community is based on the reputation score of the inviting member, among the set of inviting members, whose invitation to join the online community has been accepted by that member.

32. A non-transitory computer readable medium including a computer program product directly loadable into a memory of a computer, the computer program product comprising software code means to perform the method of claim 17 when run on the computer.
